(19) United States
(12) Patent Application Publication
(10) Pub. No.: US 2017/0018873 A1
(43) Pub. Date: Jan. 19, 2017

(54) ALIGNMENT MODULE FOR PLUG-IN CONNECTOR

(71) Applicant: AMPHENOL-TUCHEL ELECTRONICS GMBH, Heilbronn (DE)

(72) Inventor: MICHAEL S. BERTSCH, Heilbronn (DE)

(21) Appl. No.: 15/124,152

(22) PCT Filed: Feb. 2, 2015
(86) PCT No.: PCT/DE2015/100045

§ 371 Date: Sep. 7, 2016

(30) Foreign Application Priority Data
Mar. 12, 2014 (DE) 20 2014 101 121.8

(51) Int. Cl. H01R 13/629; H01R 13/514; H01R 13/645

(52) U.S. Cl. CPC H01R 13/629; H01R 13/6453; H01R 13/514

(57) ABSTRACT

The invention relates to an alignment module for a plug-in connector for plugging into a rectangular module frame of a modular plug-in connector, said alignment module comprising: a) a substantially rectangular module body, b) from which module body two pins protrude, c) in addition, at least one securing element which is arranged on the module body in order to secure the alignment module for the plug-in connector to the module frame of the modular plug-in connector.

The present invention relates to an alignment module for plug-in connector having the features of claim 1 and to a modular plug-in connector having the features of claim 9.

The present invention therefore relates in particular to an alignment module for plug-in connector for a modular plug-in connector, in which a module body of the alignment module for plug-in connector has two pins protruding from the module body, which are preferably arranged diametrically in opposing positions, such that, when the modular plug-in connector is plugged together, opposing pins of the respective alignment modules for plug-in connector contact one another first.

Different modular plug-in connectors are known in the prior art.

Modular plug-in connector systems or modular plug-in connections generally have a socket plug-in connector and a pin plug-in connector, which can be brought into engagement with one another.

The plug-in connectors therefore have a socket module frame, in which socket modules are inserted, which together define the socket module plug-in connector. Electrical contacts are arranged in the socket modules.

Modular plug-in connector systems thus also have a pin module, which cooperates with a pin module frame and defines the pin plug-in connector part. Electrical contacts corresponding to the socket module are usually arranged in the pin module.

Besides the socket with electrical contacts, pneumatic and other contacts can also be accommodated. In this way, modular plug-in connector systems fitted differently with power contacts, signal contacts or even other contacts can be provided in order to meet the different requirements of its applications.

It is also usual to deliver such modular plug-in connector systems in individual parts, such that the manufacturers and users can assemble suitable module systems adapted to their application.

Module frames are generally formed such that the modules to be used can be inserted into the module frame in a fixed plug-in grid and can be latched or secured there. In this way, one or more modules of this type can be inserted adjacently into the module frame and latched thereto, depending on the socket module frame size.

A problem encountered with the modular plug-in connector system known in the prior art is therefore the fact that it is difficult to bring the socket and pin modules of the plug-in connector system reliably into engagement with one another, in particular in inaccessible plug-in positions. This is hampered in particular on account of the fact that the modules often have an end face lying in a common plane, such that each of the opposing plug-in connector pairs can slide to and fro via its end face on the other plug-in connector, and it is difficult to bring the plug-in connectors into the desired engagement.

It is also undesirable that the contact modules bump against one another, since damage could also be caused as a result, before proper contact has been established between the contacts, depending on the embodiment of the pin or socket modules.

The object of the present invention is therefore to overcome the aforementioned disadvantages and in particular to provide a device with which it is possible to reliably bring plug-in connector pairs of modular plug-in connectors into the proper position of engagement with one another.

This object is achieved with an alignment module for plug-in connector according to claim 1 and with a modular plug-in connector according to claim 9.

Here, the basic concept of the present invention is to provide, in the case of a modular plug-in connector, an alignment module for plug-in connector for plugging into the module frame of the modular plug-in connector, which alignment module for plug-in connector has pins, preferably two pins, protruding with respect to the module bodies of the modular plug-in connector system, which pins serve as a guide means for insertion of the plug-in connector pairs of the modular plug-in connector system.

In other words, an alignment module for plug-in connector according to the invention is correspondingly arranged at corresponding positions in the module frame of the modular plug-in connector, both on the pin side and on the socket side, such that the mutually opposed protruding pins run over one another and bring the two plug pairs into a proper state of engagement.

In a particularly advantageous embodiment of the invention, the alignment module for plug-in connector is hermaphroditic. In this way it can be inserted both on the pin module side and on the socket module side of the respective plug-in connector pairs of the modular plug-in connector system and the object according to the invention can be solved by means of a single module.

It is also advantageous when the pins on the module body protrude at two diametrically opposed corners, more specifically in the plugging direction E of the module with respect to the module frame.

It is also preferred to form the pins identically and preferably to provide these with a rectangular cross section.

It is also preferred when the pins have, at their plug-in end, insertion bevels which, when two opposing alignment modules for plug-in connector meet, contact one another and thus act as guides surfaces.

Provision is also advantageously made for the alignment module for plug-in connector according to the invention to have securing elements, preferably sprung securing elements, so as to be fixed in or plugged into a module frame of a modular plug-in connector system.

It is also preferred when the securing elements have a detent lug for latching with the module frame and more preferably when, besides the detent lugs, recesses are provided, in which lugs integrally molded on the module frame can engage. A particularly secure holding and supporting of the alignment modules for plug-in connector in the module frame is thus ensured.

A further aspect of the present invention is the provision of a modular plug-in connector comprising at least one socket module having a socket module frame and preferably socket module bodies which can be plugged into the socket module frame in a plug-in grid R, more specifically in a plug-in position in which the socket modules are latched with the socket module frame, and also having a pin module having a pin module frame with an identical plug-in grid R for plugging the socket modules into the socket module frame, wherein an alignment module for plug-in connector (as described above) is also provided for each module frame, for assembly in opposing corresponding plug-in positions of the plug-in grid in the relevant module frame.

A modular plug-in connector system is thus provided which ensures that, when a socket plug and a pin plug are plugged together, the different socket modules which can be brought into engagement with one another are brought into their correct position of engagement with the aid of the alignment module for plug-in connector.

Provision is also advantageously made for a modular plug-in connector to be provided, wherein the alignment modules for plug-in connector are formed with their securing elements such that they can be inserted into any plug-in place within the plug-in grid of the module frame of the modular plug-in connector. In this way, the user has the option to arrange the socket modules or the pin modules in the relevant module frame such that these can be introduced at a desired assembly position, whereas a plug-in place provided in the module frame for the alignment module for plug-in connector according to the invention can be specifically selected. In this way, a coding of the modular plug-in connector system can be provided at the same time, since, by rearrangement of the socket modules or pin modules and suitable arrangement of the alignment modules for plug-in connector, other modular plug-in connector systems provided with comparable socket modules and pin modules can each also be brought into engagement or plugged together only with the corresponding plug-in connector provided therefor.

Provision is also advantageously made for the pins of the respective alignment module for plug-in connector, when modules are inserted into the module frames, to protrude relative to the end face or the plane spanned by the end faces of the modules, such that, when the socket is plugged together, the mutually opposed (protruding) pins of opposing alignment modules for plug-in connector meet and contact one another first. When the plug-in connector pairs of the modular plug-in connector system are plugged together, these are then preferably guided against one another via the insertion bevels, such that the plug-in connector pairs can be brought into their proper plugged-in position or position of engagement.

The invention will be described merely by way of example hereinafter on the basis of an advantageous embodiment with reference to the drawings, in which:

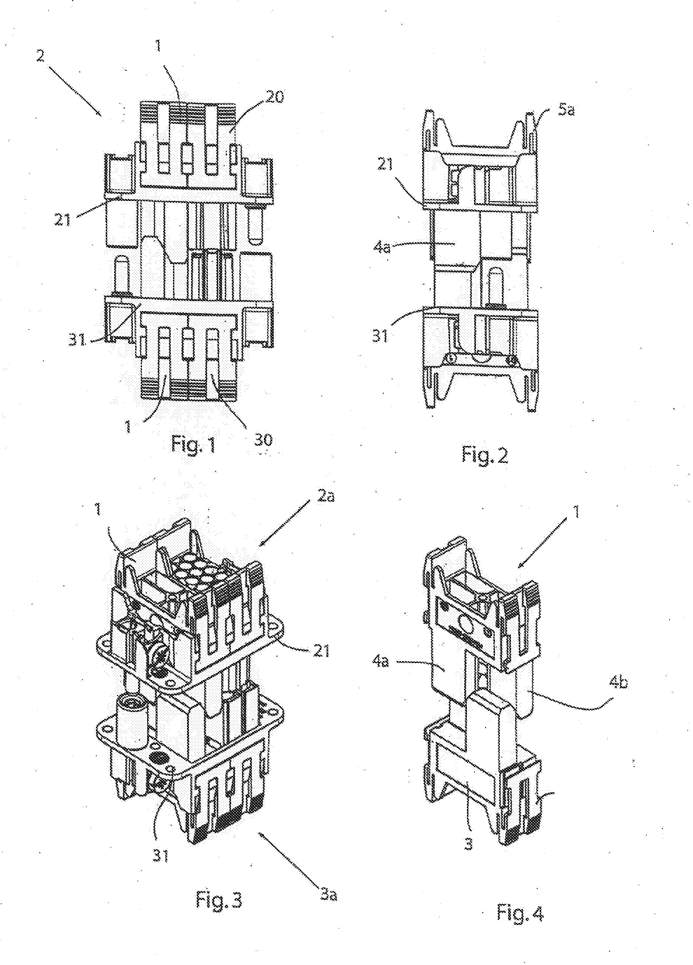

FIG. 1 shows a side view of a modular plug-in connector system;

FIG. 2 shows a further side view of the modular plug-in connector system according to FIG. 1;

FIG. 3 shows a perspective view of the modular plug-in connector system according to FIG. 1 and FIG. 2;

FIG. 4 shows a perspective view of two corresponding alignment modules for plug-in connector which face one another;

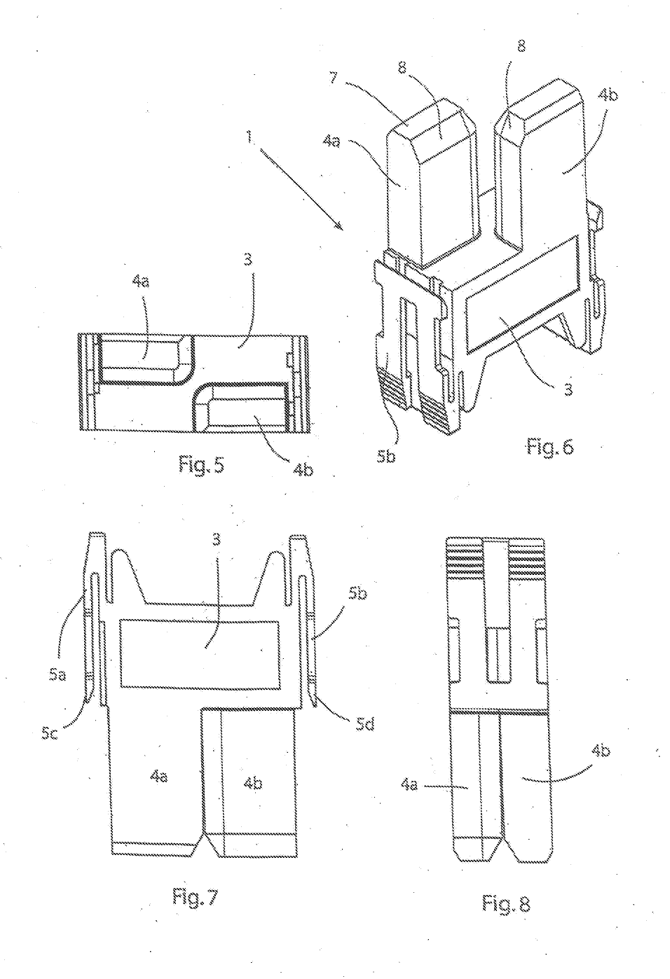

FIG. 5 shows a plan view of an alignment module for plug-in connector according to FIG. 4;

FIG. 6 shows a perspective view of an individual alignment module for plug-in connector;

FIG. 7 shows a side view of an alignment module for plug-in connector according to FIG. 6;

FIG. 8 shows a further side view of an alignment module for plug-in connector according to FIG. 6.

An exemplary embodiment of a modular plug-in connector system 2 is illustrated in FIG. 1 to FIG. 3. The modular plug-in connector system 2 is formed from a plug-in connector pair 2a, 2b. The socket plug-in connector 2a comprises a socket module frame 21, in which socket modules 20 are plugged in a defined plug-in grid A. The pin plug 3a comprises a plug module frame 31, in which pin modules 30 (formed in a corresponding manner for engagement in the socket modules 20) are inserted, likewise in a plug-in grid A of the plug-in module frame 31.

In FIG. 1 it can also be seen that an alignment module for plug-in connector 1 shown in FIG. 3 to FIG. 8 is inserted both in the socket module frame 21 and the plug-in module frame 31 and is latched via its securing elements 5a, 5b.

An exemplary embodiment of an alignment module for plug-in connector 1 is illustrated in FIG. 3 to FIG. 8. The alignment module for plug-in connector 1 has a substantially rectangular module body 3, wherein two pins 4a, 4b protrude from the module body 3, and wherein at least one securing element 5a, 5b is also arranged laterally on the module body 3 in order to fix the alignment module for plug-in connector 1 to the particular module frame 21, 31.

As can be seen in particular in FIG. 3, the present embodiment of the alignment module for plug-in connector 1 is hermaphroditic and this module can be used both with the pin module frame 31 and in the socket module frame 21.

Provided the alignment modules for plug-in connector 1 are each arranged at corresponding plug-in positions in the plug-in grid R of the module frames 21, 31, the front ends of the pins 4a, 4b meet one another when plugged together (as can be seen in FIG. 1 to FIG. 4), such that a guidance is ensured as the plug-in connector pairs 2a, 2b are guided together.

It can also be seen that the pins 4a, 4b are identical in terms of their form and are arranged at diametrically opposed corners of the module body and protrude therefrom.

The length of the pins 4a, 4b is selected here such that they protrude beyond the end faces of the pin modules 30 or of the socket modules 20, as can be seen also in FIG. 1 to FIG. 3. It is thus ensured that, prior to the engagement of a pin module 30 with a socket module 20, the opposing (protruding) ends of the pins 4a, 4b of the corresponding, facing alignment modules for plug-in connector 1 meet one another first and ensure the guidance as the plug-in connector pairs 2a, 2b are plugged further together.

For improved guidance, the pins 4a, 4b have insertion bevels 8 at their plug-in ends 7. The insertion bevels 8 are formed here such that two alignment modules for plug-in connector 1 contacting one another or engaging with one another when plugged together each form sliding planes at the insertion bevels 8, along which they are guided until the side faces of the pins 4a, 4b face one another and the plug-in connector pairs 2a, 2b are inserted further.

It can also be seen in FIG. 4 to FIG. 8 that a sprung securing element 5a, 5b is arranged on each side of the module body 3. The securing elements 5a, 5b point with their free end 5c, 5d in the plugging direction E of the module with respect to the module frame.

The securing elements 5a, 5b have two spring tongues, which are attached at their free end to the module body and at their resilient free end are interconnected via a crosspiece. An opening is thus formed between the two spring arms, which opening can be engaged by a detent lug on the module frame.

The invention is not limited in its realization to the preferred exemplary embodiments specified above. Rather, a number of variants are conceivable which make use of the presented solution, even in the case of embodiments that are fundamentally different.

### LIST OF REFERENCE SIGNS

Alignment module for plug-in connector and modular plug-in connector comprising an alignment module for plug-in connector

1 alignment module for plug-in connector

2 modular plug-in connector

2a, 2b plug-in connector pairs

3 module body

4a, 4b pins

5a, 5b securing elements

5c, 5d free end

6 corners

7 plug-in end

8 insertion bevels

20 socket module

21 socket module frame

22 end face

30 pin module

31 pin module frame

32 end face

A plug-in grid

E plugging direction

R plug-in grid

1. An alignment module for plug-in connector for plugging into a rectangular module frame of a modular plug-in connector, comprising:
a) a substantially rectangular module body, wherein
b) two pins protrude from the module body, and
c) wherein at least one securing element is also arranged on the module body in order to fix the alignment module for plug-in connector to the module frame of the modular plug-in connector.

2. The alignment module for plug-in connector as claimed in claim 1, characterized in that the alignment module for plug-in connector is hermaphroditic.

3. The alignment module for plug-in connector as claimed in claim 1, characterized in that the pins on the module body are each arranged at two diametrically opposed corners of the module body in a manner protruding therefrom, more specifically in the plugging direction of the alignment module for plug-in connector with respect to a module frame.

4. The alignment module for plug-in connector as claimed in claim 1, characterized in that the pins are identical and have a rectangular cross section. (Currently Amended) The alignment module for plug-in connector as claimed in claim 1, characterized in that the pins each have an insertion bevel at their plug-in end.

6. The alignment module for connector as claimed in claim 1, characterized in that the securing elements are sprung.

7. The alignment module for plug-in connector as claimed in claim 1, characterized in that the securing elements each have a detent lug or a detent recess for latching with a module frame.

8. The alignment module for plug-in connector as claimed in claim 5, characterized in that the insertion bevels are arranged on the plug-in end at least at two front-end edges.

9. A modular plug-in connector comprising at least one socket module having a socket module frame, which has a plug-in grid for plugging the socket modules into one of the plug-in positions of the plug-in grid, and also a pin module having a pin module frame with an identical plug-in grid for plugging in the pin modules, wherein an alignment module for plug-in connector as claimed in claim 1 is also provided for each module frame for assembly on the module frames in opposing corresponding plug-in positions of the plug-in grid.

10. The modular plug-in connector as claimed in claim 9, characterized in that the alignment modules for plug-in connector arc formed with their securing elements such that they can be plugged in any plug-in position within the plug-in grid of the module frame of the modular plug-in connector.

11. The modular plug-in connector as claimed in claim 9, characterized in that, when modules are inserted into the respective module frames, the pins of each alignment module for plug-in connector protrude relative to the end face of the respective other module, said end laces being formed by the modules, such that, as the plug-in connector pairs of the modular plug-in connector are plugged together, the opposing ends of the pins of the opposing alignment modules for plug-in connector contact one another first.
